(19) United States
(12) Patent Application Publication
(10) Pub. No.: US 2026/0112723 A1
(43) Pub. Date: Apr. 23, 2026

(54) THERMAL RUNAWAY EXTINGUISHING SYSTEM FOR BATTERIES

(71) Applicants: Hyundai Motor Company, Seoul (KR); Kia Corporation, Seoul (KR)

(72) Inventors: Chang Mo SUNG, Hwaseong-si (KR); Myung Sic CHOI, Hwaseong-si (KR); Min Seok SEO, Hwaseong-si (KR)

(21) Appl. No.: 19/193,517

(22) Filed: Apr. 29, 2025

(30) Foreign Application Priority Data
Oct. 21, 2024 (KR) 10-2024-0143596

(51) Int. Cl. H01M 10/633; H01M 10/48; H01M 10/613; H01M 10/6568; H01M 50/204; H01M 50/383; H01M 50/618; H01M 50/636

(52) U.S. Cl. CPC H01M 10/633; H01M 10/482; H01M 10/486; H01M 10/613; H01M 10/6568; H01M 50/383; H01M 50/618; H01M 50/636; H01M 50/204

(57) ABSTRACT

A thermal runaway extinguishing system includes: a case configured to accommodate a plurality of battery modules; cooling channels that are (i) positioned at an upper portion of the case and a lower portion of the case and (ii) configured to receive a coolant, the coolant circulating through the plurality of cooling channels; an extinguishing unit fluidly connected to the cooling channels; and a controller. The controller is configured to: determine whether thermal runaway has occurred in at least one of the battery modules; and based on a determination that the thermal runaway has occurred, (i) increase a flow rate of the coolant flowing into a battery module that is experiencing the thermal runaway or (ii) control the extinguishing unit to guide an extinguishing agent stored in the extinguishing unit to flow into the cooling channels.

### CROSS-REFERENCE TO RELATED APPLICATION

This application claims priority to and the benefit of Korean Patent Application No. 10-2024-0143596, filed on Oct. 21, 2024, the disclosure of which is incorporated herein by reference in its entirety.

### TECHNICAL FIELD

The present disclosure relates to a thermal runaway extinguishing system for batteries.

### BACKGROUND

Battery module temperature control in electric vehicle battery systems may be useful for maintaining optimal cell temperature performance. Various cooling methods, including air-cooled and water-cooled systems, can be utilized.

Thermal runaway in battery modules of a battery pack, characterized by a rapid increase in temperature, can lead to safety challenges. For instance, when the thermal runaway occurs in battery modules, an explosion can occur due to a rapid increase in temperature.

In some cases, air-cooled or water-cooled battery cooling system may not effectively control the rapidly rising or risen temperature of a battery module during thermal runaway. Additionally, in some cases involving the use of certain refrigerants, thermal runaway can worsen when the refrigerant reacts with the high temperature of the cells.

### SUMMARY

Implementations according to this disclosure provides a thermal runaway extinguishing system for batteries that can inject an extinguishing agent into cooling channels integrated with a case.

Implementations according to this disclosure provides a control method that can provide a controller including two different control units to respectively determine thermal runaway, and allow an extinguishing unit to be connected to cooling channels.

Implementations according to this disclosure provides a thermal runaway extinguishing system for batteries that can provide an open-type valve, which is located in a case so as to correspond to each of battery module assemblies and is automatically opened at a set temperature or higher, to extinguish thermal runaway regardless of whether a controller is operated.

Implementations according to this disclosure describe a thermal runaway extinguishing system for batteries includes the following configuration.

In one aspect, Implementations according to this disclosure provides a thermal runaway extinguishing system for batteries including a case configured such that a plurality of battery module assemblies is located therein, cooling channels located at upper and lower portions of the case so that a coolant circulates through the cooling channels, an extinguishing unit fluidly connected to the cooling channels, a controller configured to determine whether thermal runaway of the battery module assemblies occurs and, upon determining that the thermal runaway of the battery module assemblies occurs, increase a flow rate of the coolant into a thermally runaway battery module assembly or control the extinguishing unit so that an extinguishing agent stored in the extinguishing unit flows into the cooling channels.

In some implementations, the cooling channels can include an inlet configured to such that the coolant flows thereinto from an outside of the case, and an outlet configured such that the coolant is discharged to the outside of the case therethrough. In some implementations, the cooling channels can further include an upper cooling channel located at an upper portion of the case and a lower cooling channel located at a lower portion of the case, the inlet can be fluidly connected to an upper cooling channel inlet and a lower cooling channel inlet, and the outlet can be fluidly connected an upper cooling channel outlet and a lower cooling channel outlet.

In some implementations, the thermal runaway extinguishing system for batteries can further include a cutoff valve located at the lower cooling channel inlet to block the lower cooling channel inlet upon determining that thermal runaway of the battery module assemblies occurs.

In some implementations, the extinguishing unit can be located adjacent to the upper cooling channel inlet, and the extinguishing unit can include an injection valve controlled so that the extinguishing unit is selectively fluidly connected to the upper cooling channel.

In some implementations, the controller can include a valve control unit configured to determine that the thermal runaway of the battery module assemblies occurs and open the injection valve of the extinguishing unit, if a flow rate of the coolant in the upper cooling channel outlet is less than or equal to a set value, and a battery management system configured to determine the thermally runaway battery module assembly among the battery module assemblies in response to temperature signals of the battery module assemblies and switch a cutoff valve at the lower cooling channel inlet to a closed state to increase a flow rate of the coolant flowing into the upper cooling channel.

In some implementations, the thermal runaway extinguishing system for batteries can further include an open-type valve located at a position of each of the battery module assemblies on an upper surface of the case so as to face the cooling channels, and opened at a set temperature or higher.

In some implementations, the open-type valve corresponding to the thermally runaway battery module assembly can be opened so that the extinguishing agent introduced from the extinguishing unit is injected onto the thermally runaway battery module assembly.

In some implementations, the extinguishing unit can include a first chamber fluidly connected to the cooling channels and configured to store the extinguishing agent, and a second chamber configured to provide compressed gas to the first chamber.

In another aspect, implementations according to this disclosure provides a thermal runaway extinguishing method for batteries including measuring, by a controller, temperatures of a plurality of battery module assemblies, determining, by the controller, whether the battery module assemblies are in a thermal runaway state, and performing, by the controller, valve control of cooling channels upon determining that the battery module assemblies are in the thermal runaway state, and injecting an extinguishing agent stored in an extinguishing unit into the cooling channels.

In some implementations, determining, by the controller, whether the battery module assemblies are in the thermal runaway state can include determining, by a battery management system of the controller, whether temperatures of the battery module assemblies are higher than or equal to a set temperature, and upon determining that the temperature of at least one of the battery module assemblies measured by the battery management system is higher than or equal to the set temperature, determining that the corresponding battery module assembly is in the thermal runaway state.

In some implementations, performing, by the controller, the valve control of the cooling channels upon determining that the battery module assemblies are in the thermal runaway state can include closing, by a battery management system of the controller, a cutoff valve located at a lower cooling channel inlet.

In some implementations, injecting the extinguishing agent stored in the extinguishing unit into the cooling channels can include opening, by a valve control unit of the controller, an injection valve of the extinguishing unit to inject the extinguishing agent into an upper cooling channel inlet.

In some implementations, the thermal runaway extinguishing method for batteries can further include injecting the extinguishing agent injected into the upper cooling channel inlet onto the battery module assembly determined in the thermal runaway state through the open-type valve corresponding to the battery module assembly determined in the thermal runaway state.

In some implementations, injecting the extinguishing agent stored in the extinguishing unit into the cooling channels can include determining, by a valve control unit of the controller, whether a flow rate of the coolant in an upper cooling channel outlet is less than or equal to a set value, and opening an injection valve of the extinguishing unit upon determining that the flow rate of the coolant in the upper cooling channel outlet is less than or equal to the set value.

### BRIEF DESCRIPTION OF THE DRAWINGS

FIG. 1 is a diagram illustrating an example of a thermal runaway extinguishing system for batteries.

FIG. 2 is a side view of an example of a case of a thermal runaway extinguishing system for batteries.

FIG. 3 is a side view illustrating an example of a thermally runaway battery module.

FIG. 4 is a diagram illustrating an example of an extinguishing unit.

FIG. 5 is a flowchart illustrating an example of a thermal runaway extinguishing method for batteries.

### DETAILED DESCRIPTION

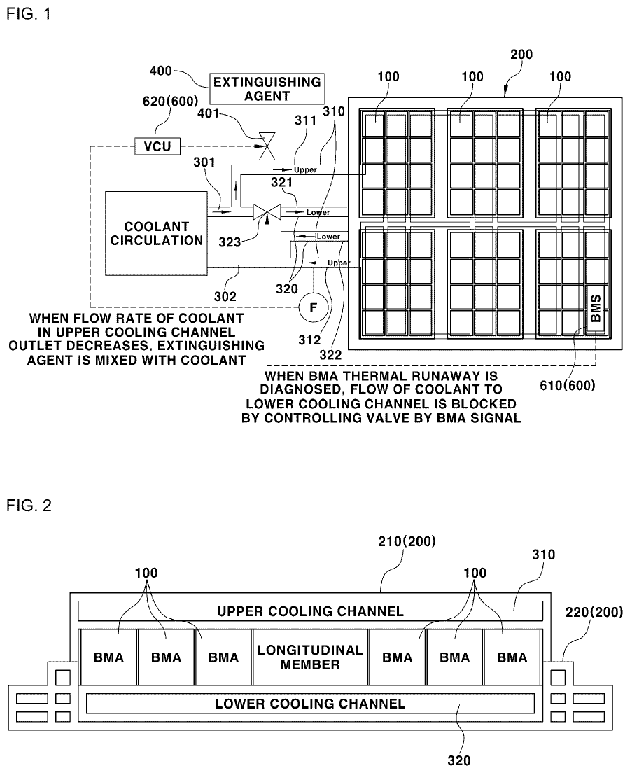

Referring to FIG. 1, a thermal runaway extinguishing system for batteries is shown. The thermal runaway extinguishing system includes a case 200 including a plurality of battery module assemblies (BMAs) 100, and the case 200 can accommodate the plurality of battery module assemblies 100 connected in series or in parallel so as to supply power.

In some examples, the battery module assembly 100 can be provided in the form of a battery component that is implemented with a separator between an anode material and a cathode material, rolled, and sealed by a battery pack, and the battery module assembly 100 can be an electrolyte battery using an electrolyte, such as a lithium ion battery, or an all-solid-state battery using solid electrolytes.

Furthermore, the case 200 can be provided with power terminals exposed to the outside to supply power to the outside, and the power terminals can include an anode terminal and a cathode terminal.

As such, battery spaces that respectively accommodate the plurality of battery module assemblies 100 can be formed in the case 200, and the case 200 can be sealed by a case cover located on the upper surface of the case 200.

Further, cooling channels 300 that penetrate the inside of the case 200 so that a coolant flows along the cooling channels 300 can be provided. In some implementations, the cooling channels 300 can include an upper cooling channel 310 provided along the upper end of the case 200 so that the coolant flows therein and a lower cooling channel 320 provided along the lower end of the case 200 so that the coolant flows therein.

In addition, the cooling channels 300 can include a condenser that is located outside the case 200 to pressurize the coolant and cool the coolant that circulates through the case 200 and is discharged from the case 200, a heat exchanger, and a pump configured to pressurize the coolant.

The cooling channels 300 can include the upper cooling channel 310 provided on the upper surfaces of the battery module assemblies 100 and the lower cooling channel 320 provided on the lower surfaces of the battery module assemblies 100 based on the case 200, and the upper cooling channel 310 and the lower cooling channel 320 can be fluidly connected to an upper cooling channel inlet 311 and a lower cooling channel inlet 321 that branch off from an inlet 301 of the cooling channels 300, respectively.

The upper cooling channel inlet 311 and the lower cooling channel inlet 321 through which the coolant flows into the case 200 are located adjacent to one side based on the case 200. In addition, the coolant flowing out of the case 200 can be fluidly connected to an outlet 302 of the cooling channels 300 through an upper cooling channel outlet 312 and a lower cooling channel outlet 322. The outlet 302 of the cooling channels 300 can be located adjacent to the other side based on the case 200. In some implementations, the inlet 301 of the cooling channels 300 and the outlet 302 of the cooling channels 300 can be located on the same side of the case 200, and the coolant flowing into the inlet 301 flows into the case 200 adjacent to the battery module assemblies 100 through the upper cooling channel 310 and the lower cooling channel 320 and is discharged to the outside of the case 200 through the outlet 302.

An extinguishing unit 400 can be configured such that an injection valve 401 is opened to inject an extinguishing agent into the inlet 301 of the cooling channels 300 upon determining that thermal runaway of the battery module assemblies 100 occurs. In some examples, the extinguishing unit 400 is configured to be fluidly connected to the upper cooling channel inlet 311 for the cooling channels 300, and the controller 600 is configured to open the injection valve 401 so that the extinguishing agent is injected into the upper cooling channel inlet 311, if the thermal runaway of the battery module assemblies 100 is detected.

The controller 600 can include a battery management system (hereinafter, BMS) 610 that can receive temperature information of the battery module assemblies 100. In some examples, the BMS 610 can measure battery state information, such as voltage, current, temperature, and internal resistance of each of the plurality of battery module assemblies 100, estimate an SoC and an SoH based on the measured battery state information, protect the batteries, and perform cell balancing.

In addition, the controller 600 can perform valve control. In one implementation of the present disclosure, the controller 600 can control opening of the injection valve 401 located in the extinguishing unit 400, and detect the flow rate of the coolant flowing into the upper cooling channel outlet 312. In some examples, the controller 600 according to the present disclosure can include a valve control unit (hereinafter, VCU) 620, and if the flow rate of the coolant into the upper cooling channel outlet 312 is less than or equal to a set value, the VCU 620 can determine that thermal runaway of the battery module assemblies 100 occurs, and open the injection valve 401 located in the extinguishing unit 400 to inject the extinguishing agent into the upper cooling channel 310.

In one implementation of the present disclosure, the BMS 610 is located within the case 200, and can determine whether thermal runaway of each of the battery module assemblies 100 occurs, and control a cutoff valve 323 located at the lower cooling channel inlet 321 to be closed, upon determined that thermal runaway of at least one battery module assembly 100 occurs.

As such, in the present disclosure, the controller 600 determines whether the temperature of each of battery module assemblies 100 is higher than or equal to a set temperature and, upon determining that the temperature of at least one battery module assembly 100 is higher than or equal to the set temperature, determines that thermal runaway of the corresponding battery module assembly 100 occurs through the BMS 610, and determines that thermal runaway of the battery module assemblies 100 occurs, upon determining that the flow rate of the coolant flowing into the upper cooling channel outlet 312 is less than or equal to the set value through the VCU 620.

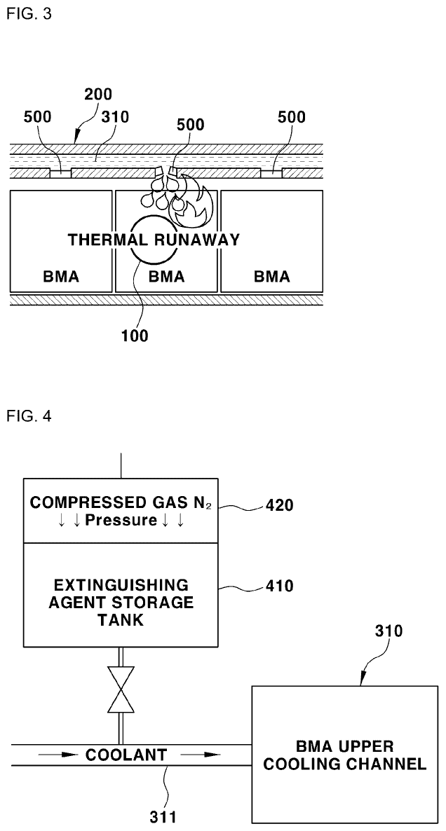

FIGS. 2 and 3 are cross-sectional views showing the case 200 and the battery module assemblies 100 and open-type valves 500 mounted in the case 200.

The case 200 can be configured as an integral body including the upper cooling channel 310 and the lower cooling channel 320, and the plurality of battery module assemblies 100 can be mounted adjacent to each other in the case 200. The upper cooling channel 310 and the lower cooling channel 320 can be located adjacent to the upper and lower ends of the plurality of battery module assemblies 100. In some examples, the upper cooling channel 310 and the lower cooling channel 320 can be located on an upper case 210 and a lower case 220.

Furthermore, the open-type valves 500 facing the battery module assemblies 100 respectively are located in the case 200. The open-type valves 500 of the present disclosure are opened at a set temperature or higher, and are configured such that, in a state in which each of the open-type valves 500 is opened, the upper cooling channel 310 is fluidly connected to the internal space of the case 200 in which a corresponding one of the battery module assemblies 100 is mounted.

The open-type valves 500 are located to correspond to the battery module assemblies 100, respectively, and the set temperature to open the open-type valves 500, i.e., an opening temperature, can be set so that the open-type valve 500 is opened if a corresponding battery module assembly 100 is in the thermal runaway state. Furthermore, the controller 600 can control the extinguishing unit 400 to inject the extinguishing agent into the upper cooling channel inlet 311 in the thermal runaway state of the battery module assemblies 100, and accordingly, the coolant and the extinguishing agent can be injected into the thermally runaway battery module assembly 100 in the open state of the corresponding open-type valve 500.

In addition, since the coolant and the extinguishing agent are injected into the thermally runaway battery module assembly 100 in the open state of the corresponding open-type valve 500, the flow rate of the coolant discharged through the upper cooling channel outlet 312 can be relatively reduced. Therefore, the VCU 620 can determine that at least one of the battery module assemblies 100 is in the thermal runaway state if the flow rate of the coolant into the upper cooling channel outlet 312 is less than or equal to the set value.

As such, the controller 600 according to the present disclosure can determine the thermal runaway state of the battery module assemblies 100, and perform control to open the injection valve 401 to allow the extinguishing unit 400 to be connected to the upper cooling channel inlet 311, upon determining that at least one of the battery module assemblies 100 is in the thermal runaway state, through the BMS 610 and the VCU 620. At the same time, the BMS 610 performs control to switch the cutoff valve 323 to a closed state so as to prevent the coolant from flowing into the lower cooling channel inlet 321.

In some examples, the BMS 610 can directly determine the thermal runaway state of the battery module assemblies 100 by measuring the temperatures of the battery module assemblies 100, and independently of the BMS 610, the VCU 620 can determine the thermal runaway state of the battery module assemblies 100 based on a decrease in the flow rate of the coolant flowing into the upper cooling channel outlet 312.

As one implementation of the present disclosure, if each of the BMS 610 and the VCU 620 performs thermal runaway determination, a fire extinguishing mechanism corresponding to the thermal runaway state can be performed by an independent unit of the controller 600. That is, if the BMS 610 determines that at least one of the battery module assemblies 100 is in the thermal runaway state based on the temperatures of the battery module assemblies 100, the BMS 610 closes the cutoff valve 323 located at the lower cooling channel inlet 321 to relatively increase the flow rate of the coolant flowing into the upper cooling channel inlet 311, and increases the flow rate of the coolant flowing into the thermally runaway battery module assembly 100 through the corresponding open-type valve 500. In contrast, if the flow rate of the coolant into the upper cooling channel outlet 312 is less than or equal to the set value, the VCU 620 determines that the coolant is flowing into the thermally runaway battery module assembly 100 through the open end of the corresponding open-type valve 500 due to the thermal runaway state of the battery module assembly 100, and opens the injection valve 401 of the extinguishing unit 400. That is, the BMS 610 and the VCU 620 perform control to perform an independent extinguishing function, and in one implementation of the present disclosure, the BMS 610 and the VCU 620 perform control to perform independent thermal runaway diagnosis and the extinguishing function corresponding thereto.

Here, when one of the BMS 610 and the VCU 620 of the controller 600 fails, the extinguishing function can be performed through the other that is capable of being operated normally. For example, if the VCU 620 is normally operated in the failure state of the BMS 610, the VCU 620 determines a decrease in the flow rate of the coolant into the upper cooling channel outlet 312, and controls the injection valve 401 so that the extinguishing agent is injected into the coolant supplied to the upper cooling channel inlet 311 based on the decrease in the flow rate. Thereby, the extinguishing agent is mixed with the coolant circulated to the upper cooling channel 310, and the extinguishing agent and the coolant are injected to the corresponding battery module assembly 100 through the open-type valve 500 which is opened.

On the contrary, if the BMS 610 is normally operated in the failure state of the VCU 620, the BMS 610 determines thermal runaway of the corresponding battery module assembly 100 based on measurement of the temperatures of the battery module assemblies 100, and controls the cutoff valve 323 to block supply of the coolant to the lower cooling channel 320. Thereby, the flow rate of the coolant supplied to the upper cooling channel 310 can be increased, and the increased coolant supplied to the upper cooling channel 310 can be supplied to the thermally run away battery module assembly 100.

As described above, the controller 600 can include the BMS 610 and the VCU 620 that can perform control independently of each other, and perform control for extinguishing thermal runaway of the battery module assembly 100 in response to operation of at least one control unit of the controller 600.

FIG. 4 shows the configuration of the extinguishing unit 400 fluidly connected to the upper cooling channel 310 according to one implementation of the present disclosure.

As shown in this figure, the extinguishing unit 400 includes a first chamber 410 including the extinguishing agent and fluidly connected to the upper cooling channel inlet 311, and a second chamber 420 located at the rear end of the first chamber 410 and configured to apply pressure to the first chamber 410. A gas with low reactivity is stored at a high pressure in the second chamber 420 and provides a predetermined pressure so that the extinguishing agent stored in the first chamber 410 is injected into the upper cooling channel inlet 311 when the injection valve 401 fastened to the first chamber 410 is opened.

The gas stored at a high pressure in the second chamber 420 includes N₂ or CO₂, and can apply pressure to the extinguishing agent in the first chamber 410 so that the extinguishing agent is injected into the upper cooling channel inlet 311 without flowing backward.

Furthermore, since if the injection valve 401 fluidly connected to the first chamber 410 is opened, the partition wall of the second chamber 420 in which the compressed gas is stored is damaged and thus the compressed gas can be introduced into the first chamber 410, the compressed gas can include a gas that performs a function as an extinguishing agent.

As one implementation of the present disclosure, the extinguishing agent can include a foaming agent, a foam stabilizer, a foaming aid, and a pour point depressant, and the foaming agent, the foam stabilizer, the foaming aid, the pour point depressant, and an extinguishing additive can be mixed in a predetermined ratio.

The foaming agent can be biodegradable to generate bubbles when mixed with a solvent to be injected, and the foam stabilizer can stabilize the bubbles generated by the forming agent so that the bubbles can be maintained.

The foaming aid can enhance fire resistance of the generated bubbles, improve stability of the bubbles, and improve oxygen supply blockage, and as the foaming aid, a palm oil-based surfactant with excellent biodegradability can be used to prevent environmental pollution.

The pour point depressant can lower a freezing point to prevent the extinguishing agent from freezing as the temperature of the extinguishing agent decreases depending on the injection pressure. In addition, the extinguishing additive can help with extinguishment, and as the extinguishing additive, a mixture including at least one selected from the group consisting of dipropylene glycol, sodium carbonate, sodium bicarbonate, sodium sulfate, sodium phosphate, urea, potassium bicarbonate, sodium borate, ethanol, methanol, and isopropyl alcohol can be added.

Here, if the extinguishing agent includes expanded vermiculite or silicate, metal fire can be easily extinguished.

The extinguishing agent configured in this way flows into the case 200 along the upper cooling channel inlet 311, and is injected onto the thermally runaway battery module assembly 100 having a temperature higher than the set temperature along the open-type valve 500 facing the thermally runaway battery module assembly 100.

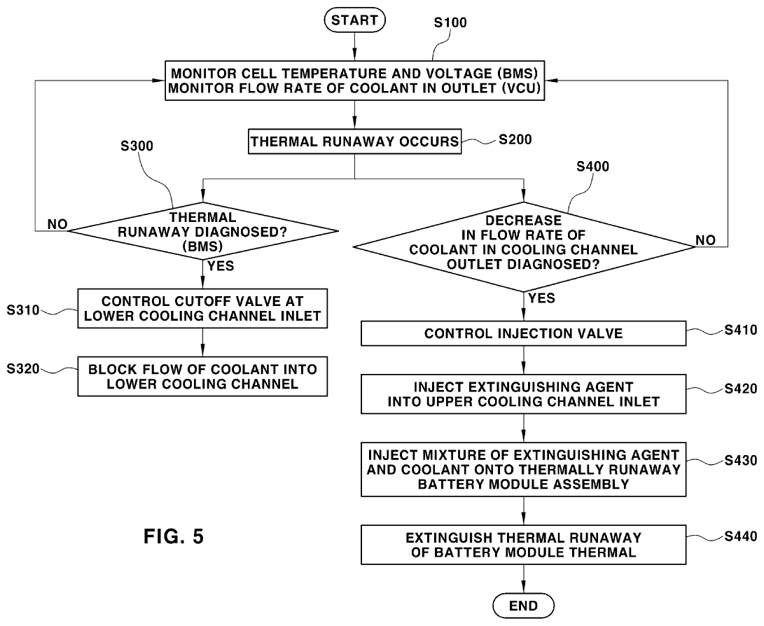

FIG. 5 is a flowchart illustrating a thermal runaway extinguishing method for batteries of a vehicle using the thermal runaway extinguishing system for batteries according to one implementation of the present disclosure.

The controller 600 receives the temperatures of the battery module assemblies 100 located in the case 200 and receives the flow rate data of the outlet 302 of the cooling channels 300. In some examples, the BMS 610 of the controller 600 receives the temperature information of the battery module assemblies 100, and the VCU 620 of the controller 600 receives the coolant flow rate information of the upper cooling channel outlet 312.

In the event that thermal runaway of the battery module assemblies 100 occurs (S200), the BMS 610 determines whether the temperatures of the battery module assemblies 100 are measured to be higher than or equal to the set temperature (S300). In addition, the VCU 620 determines whether the flow rate of the coolant of the upper cooling channel outlet 312 is less than or equal to the set value (S400).

In the event of that thermal runaway of the battery module assemblies 100 occurs, the temperature of a battery module assembly 100 in which the thermal runaway occurs is rapidly raised, and the corresponding open-type valve 500 located in the case 200 is opened in response to the raised temperature of the battery module assembly 100. Therefore, the BMS 610 can perform a function of receiving the temperatures of the battery module assemblies 100, determining whether the thermal runaway occurs in at least one of the battery module assemblies 100, and informing a user of a determination result. In addition, the VCU 620 can determine that thermal runaway of the battery module assemblies 100 occurs if the flow rate of the coolant in the upper cooling channel outlet 312 is less than or equal to the set value, because the coolant flowing into the upper cooling channel 310 flows into the thermally runaway battery module assembly 100 by opening the open-type valve 500.

Upon determining that thermal runaway occurs in at least one of the battery module assemblies 100 through the BMS 610 (S300), the BMS 610 controls the cutoff valve 323 located at the lower cooling channel inlet 321 (S310). Here, the BMS 610 closes the cutoff valve 323, thereby blocking the flow of the coolant into the case 200 through lower cooling channel inlet 321 (S320). This is to control the cutoff valve 323 so that the flow rate of the coolant flowing into the upper cooling channel 310 fluidly connected to the open-type valves 500 relatively increases.

Independently of this, if thermal runaway occurs, the VCU 620 determines whether the flow rate of the coolant into the upper cooling channel outlet 312 is less than or equal to the set value (S400). Here, upon determining that the flow rate of the coolant into the upper cooling channel outlet 312 is less than or equal to the set value, the VCU 620 controls the injection valve 401 of the extinguishing unit 400 (S410). If the injection valve 401 of the extinguishing unit 400 is controlled to be opened (S410), the extinguishing agent stored in the first chamber 410 is injected into the upper cooling channel inlet 311 (S420). A fluid, i.e., the mixture of the extinguishing agent and the coolant, flows to the upper surface of the case 200 along the upper cooling channel inlet 311, and the fluid including the coolant and the extinguishing agent is injected onto the corresponding battery module assembly 100 through the open-type valve 500 that is opened (S430).

As described above, the thermal runaway extinguishing method for batteries according to the present disclosure can increase the flow rate of the coolant and perform extinguishing agent and coolant mixing control through the BMS 610 and the VCU 620, respectively, and can thus perform extinguishment for at least one battery module assembly 100 in which thermal runaway occurs.

As is apparent from the above description, the present disclosure can obtain the following effects through the configuration, combination and usage relations disclosed in the above-described implementations.

The present disclosure provides an effect of preventing thermal runaway transfer by injecting an extinguishing agent to a battery module assembly determined to be in a thermal runaway state through a controller.

In addition, the present disclosure provides an extinguishing unit configured to inject the extinguishing agent to a cooling channel and thus configures a thermal runaway extinguishing system for batteries that may not require a separate extinguishing structure, thereby being capable of reducing cost and weight.

In addition, the present disclosure provides an open-type valve that is located at a position corresponding to each battery module assembly and automatically opened at a set temperature, thereby being capable of providing a stable effect of providing extinguishment for a thermally runaway battery module even in the failure state of a control unit.

In some implementations, a controller (e.g., the controller 60) that is described throughout this disclosure can be implemented as a memory that stores data for an algorithm for controlling operation of various components disposed in a vehicle or a program that reproduces the algorithm, and a processor that performs the above operation using the data stored in the memory. Here, the memory and the processor can be implemented as separate chips. Alternatively, the memory and the processor can be implemented as a single chip. For example, the controller 600 can include at least one of an electronic control unit (ECU), a central processing unit (CPU), a microprocessing unit (MPU), a microcontroller unit (MCU), an application processor (AP), a battery management system (BMS), a valve control unit (VCU), or any other type of process that is well known in the technical field of the present disclosure. In addition, the controller 600 can be configured as a combination of software and hardware that are capable of performing operations for at least one application or program for executing methods according to the implementations of the present disclosure.

The above detailed description is illustrative of the present disclosure. In addition, the above description is intended to illustrate the exemplary implementations of the present disclosure, and the present disclosure can be used in various other combinations, modifications, and environments. That is, it should be apparent to those skilled in the art that various substitutions, changes and modifications which are not exemplified herein but are still within the spirit and scope of the present disclosure can be made. The described implementations illustrate the best mode for implementing the technical idea of the present disclosure, and various changes required for specific application fields and uses of the present disclosure are also possible. Accordingly, the above detailed description of the disclosure is not intended to limit the present disclosure to the disclosed implementations. Further, the appended claims should be construed to include other implementations as well.

What is claimed is:

1. A thermal runaway extinguishing system for batteries, the system comprising:
a case configured to accommodate a plurality of battery modules;
a plurality of cooling channels that are (i) positioned at an upper portion of the case and a lower portion of the case and (ii) configured to receive a coolant, the coolant circulating through the plurality of cooling channels;
an extinguishing unit fluidly connected to the plurality of cooling channels; and
a controller configured to:
determine whether thermal runaway has occurred in at least one of the plurality of battery modules, and
based on a determination that the thermal runaway has occurred in at least one of the plurality of battery modules, (i) increase a flow rate of the coolant flowing into a battery module of the plurality of battery modules that is experiencing the thermal runaway or (ii) control the extinguishing unit to guide an extinguishing agent stored in the extinguishing unit to flow into the cooling channels.

2. The thermal runaway extinguishing system of claim 1, wherein the plurality of cooling channels comprise:
an inlet configured to receive the coolant from an outside of the case, and
an outlet configured discharge the coolant to the outside of the case.

3. The thermal runaway extinguishing system of claim 2, wherein the plurality of cooling channels comprise:
an upper cooling channel that (i) comprises an upper cooling channel inlet and an upper cooling channel outlet and (ii) is positioned at the upper portion of the case, and
a lower cooling channel that (i) comprises a lower cooling channel inlet and a lower cooling channel outlet and (ii) is positioned at the lower portion of the case,
wherein the inlet is fluidly connected to the upper cooling channel inlet and the lower cooling channel inlet, and
wherein the outlet is fluidly connected the upper cooling channel outlet and the lower cooling channel outlet.

4. The thermal runaway extinguishing system of claim 3, further comprising:
a cutoff valve that is (i) positioned at the lower cooling channel inlet and (ii) configured to, based on the determination that the thermal runaway has occurred, block the lower cooling channel inlet.

5. The thermal runaway extinguishing system of claim 3,
wherein the extinguishing unit is positioned adjacent to the upper cooling channel inlet, and
wherein the extinguishing unit comprises an injection valve configured to selectively establish a fluid connection between the extinguishing unit and the upper cooling channel.

6. The thermal runaway extinguishing system of claim 5, wherein the controller comprises:
a valve control unit configured to (i) determine that the thermal runaway has occurred in at least one of the plurality of battery modules and (ii) based on a flow rate of the coolant at the upper cooling channel outlet being less than or equal to a set value, open the injection valve of the extinguishing unit, and
a battery management system that is configured to, based on temperature signals of the plurality of battery modules, (i) determine a battery module of the plurality of battery modules that is experiencing the thermal runaway and (ii) switch a cutoff valve at the lower cooling channel inlet to a closed state to thereby increase a flow rate of the coolant flowing into the upper cooling channel.

7. The thermal runaway extinguishing system of claim 1,
wherein the plurality of cooling channels comprise an upper cooling channel that (i) comprises an upper channel inlet and an upper channel outlet and (ii) is positioned at the upper portion of the case, and
wherein the thermal runaway extinguishing system further comprises:
a plurality of open-type valves that (i) are positioned at an upper surface of the case associated with two or more of the plurality of battery modules, (ii) face the upper cooling channel, and (iii) are configured to be opened at a temperature that is greater than or equal to a set temperature.

8. The thermal runaway extinguishing system of claim 7, wherein, based on an open-type valve of the plurality of the open-type valves that is associated with a battery module experiencing the thermal runaway being opened, the open-type valve is configured to guide the extinguishing agent that is introduced from the extinguishing unit to be injected onto the battery module experiencing the thermal runaway.

9. The thermal runaway extinguishing system of claim 1, wherein the extinguishing unit defines:
a first chamber that is fluidly connected to the plurality of cooling channels and that is configured to store the extinguishing agent, and
a second chamber that is configured to provide compressed gas to the first chamber.

10. A thermal runaway extinguishing method for batteries, the method comprising:
measuring, by a controller, temperatures of a plurality of battery modules;
determining, by the controller, whether at least one of the plurality of battery modules is in a thermal runaway state; and
performing, by the controller and based on a determination that at least one of the plurality of the battery modules is in the thermal runaway state, valve control of at least one of a plurality of cooling channels; and
injecting, by the controller, an extinguishing agent stored in an extinguishing unit into at least one of the plurality of cooling channels.

11. The thermal runaway extinguishing method of claim 10, wherein determining, by the controller, whether at least one of the plurality of battery modules is in the thermal runaway state comprises:
determining, by a battery management system of the controller, whether a temperature of at least one of the plurality of battery modules is higher than or equal to a set temperature; and
upon determining that the temperature of at least one of the plurality of battery modules is higher than or equal to the set temperature, determining that the corresponding battery module is in the thermal runaway state.

12. The thermal runaway extinguishing method of claim 10, wherein performing, by the controller, the valve control of at least one of the plurality of cooling channels comprises:
closing, by a battery management system of the controller, a cutoff valve positioned at a lower cooling channel inlet.

13. The thermal runaway extinguishing method of claim 10, wherein injecting the extinguishing agent stored in the extinguishing unit into at least one of the plurality of cooling channels comprises:
opening, by a valve control unit of the controller, an injection valve of the extinguishing unit to inject the extinguishing agent into an upper cooling channel inlet.

14. The thermal runaway extinguishing method of claim 13, further comprising:
injecting, through an open-type valve associated with a battery module of the plurality of battery modules that is in the thermal runaway state, the extinguishing agent that has been injected into the upper cooling channel inlet onto the battery module that is in the thermal runaway state.

15. The thermal runaway extinguishing method of claim 10, wherein injecting the extinguishing agent stored in the extinguishing unit into at least one of the plurality of cooling channels comprises:
determining, by a valve control unit of the controller, whether a flow rate of a coolant in an upper cooling channel outlet is less than or equal to a set value; and
opening an injection valve of the extinguishing unit based on a determination that the flow rate of the coolant in the upper cooling channel outlet is less than or equal to the set value.

16. A thermal runaway extinguishing system for batteries, the system comprising:
a case configured to accommodate a plurality of battery modules;
a plurality of cooling channels that are configured to guide a coolant to circulate through the cooling channels;
an extinguishing unit fluidly connected to the cooling channels; and
a controller configured to:
determine whether thermal runaway has occurred in at least one of the plurality of battery modules, and
based on a determination that the thermal runaway has occurred in at least one of the plurality of battery modules, (i) increase a flow rate of the coolant flowing into a battery module of the plurality of battery modules that is experiencing the thermal runaway or (ii) control the extinguishing unit to guide an extinguishing agent stored in the extinguishing unit to flow into the cooling channels.

17. The thermal runaway extinguishing system of claim 16,
wherein the extinguishing unit is positioned adjacent to a cooling channel inlet of a cooling channel of the plurality of cooling channels, and
wherein the extinguishing unit comprises an injection valve configured to selectively establish a fluid connection between the extinguishing unit and the cooling channel.

18. The thermal runaway extinguishing system of claim 17, wherein the controller comprises:
a valve control unit configured to (i) determine that the thermal runaway has occurred in at least one of the plurality of battery modules and (ii) based on a flow rate of the coolant at an cooling channel outlet of the cooling channel being less than or equal to a set value, open the injection valve of the extinguishing unit.

19. The thermal runaway extinguishing system of claim 18, wherein the thermal runaway extinguishing system further comprises:
a plurality of open-type valves that (i) are positioned at the case associated with two or more of the plurality of battery modules, (ii) face the cooling channel, and (iii) are configured to be opened at a temperature that is greater than or equal to a set temperature.

20. The thermal runaway extinguishing system of claim 18, wherein, based on an open-type valve of the plurality of the open-type valves that is associated with a battery module experiencing the thermal runaway being opened, the open-type valve is configured to guide the extinguishing agent to be injected onto the battery module experiencing the thermal runaway.
